(19) United States
(12) Patent Application Publication
(10) Pub. No.: US 2013/0003968 A1
(43) Pub. Date: Jan. 3, 2013

(54) METHOD AND APPARATUS FOR GENERATING SESSION KEY AND CLUSTER KEY

(75) Inventors: You-Sung KANG, Daejeon (KR); Doo-Ho Choi, Cheonan (KR); Hyun-Sook Cho, Daejeon (KR)

(73) Assignee: Electronics and Telecommunications Research Institute, Daejeon (KR)

(21) Appl. No.: 13/538,781

(22) Filed: Jun. 29, 2012

(30) Foreign Application Priority Data
Jun. 30, 2011 (KR) 10-2011-0065061

(51) Int. Cl. H04L 9/00

(52) U.S. Cl. 380/46

(57) ABSTRACT

Disclosed herein are a method and apparatus for generating a session key and a cluster key using a network coding scheme. The apparatus includes a random number generation unit, a combination generation unit, a combination transmission unit, a coding result reception unit, and a restoration unit. The random number generation unit generates the random number of a node. The combination generation unit generates a combination based on a master key of the node and the random number. The combination transmission unit transfers the combination to a key distribution server. The coding result reception unit receives a result of a network coding, corresponding to an ID of the node, from the key distribution server. The restoration unit for generating a session key by restoring a random number, corresponding to a counterpart node of the node, using the result of the network coding and the random number.

### CROSS REFERENCE TO RELATED APPLICATION

This application claims the benefit of Korean Patent Application No. 10-2011-0065061, filed on Jun. 30, 2011, which is hereby incorporated by reference in its entirety into this application.

### BACKGROUND OF THE INVENTION

1. Technical Field

The present invention relates generally to a method and apparatus for generating a session key and a cluster key and, more particularly, to a method and apparatus for generating a session key and a cluster key using a network coding scheme so that a master key is not directly used in message encryption in a digital communication apparatus.

2. Description of the Related Art

A digital communication apparatus generates a specific key in order to perform secure communication with another digital communication apparatus.

One of conventional key generation methods is a method of generating a session key using a network coding scheme. Here, the session key corresponds to an encryption key that is used only during one communication session between two parties in communication with each other. The session key is a temporary key which is used to preclude the possibility that a key may be calculated by analyzing cryptograms when there are many cryptograms that use one key.

A key distribution server is included in environments in which a session key is generated using a network coding scheme. Here, the key distribution server distributes keys to nodes that request key exchange by applying the network coding scheme to the master keys of the respective nodes.

Such a method of distributing keys using the network coding scheme is configured such that a node directly detects the master key of a counterpart node and encrypts a communication message.

As described above, in the conventional key distribution method, data having the same value is always transferred between two specific nodes because the key distribution server applies the network coding scheme to the master key of each node. Accordingly, a playback attack is possible in which a malicious attacker disguises himself as the key distribution server. That is, there is a problem in that an attacker may imitate the key distribution server if the attacker obtains the Exclusive OR (XOR) combination of the master key of each node corresponding to data that is transmitted by the key distribution server over a radio section.

Furthermore, the conventional key distribution method is problematic in that the possibility of key exposure increases because of the direct use of the master key of each node because the master key is directly used in message encryption.

### SUMMARY OF THE INVENTION

Accordingly, the present invention has been made keeping in mind the above problems occurring in the prior art, and an object of the present invention is to provide a method and apparatus for generating a session key and a cluster key using a network coding scheme so that a master key is not directly used in message encryption in a digital communication apparatus.

In order to accomplish the above object, the present invention provides an apparatus for generating a session key, including a random number generation unit for generating a random number of a node; a combination generation unit for generating a combination based on a master key of the node and the random number, a combination transmission unit for transferring the combination to a key distribution server; a coding result reception unit for receiving a result of a network coding, corresponding to an ID of the node, from the key distribution server; and a restoration unit for generating a session key by restoring a random number, corresponding to a counter part node of the node, using the result of the network coding and the random number.

The combination generation unit may generate the combination by performing an Exclusive OR (XOR) operation on the master key of the node and the random number.

The coding result reception unit may receive the result of the network coding, performed based on the result of the search of a look-up table corresponding to the ID of the node and combinations corresponding to a plurality of nodes, from the key distribution server.

In order to accomplish the above object, the present invention provides an apparatus for generating a cluster key, including a random number generation unit for generating a random number of a node; a combination generation unit for generating a combination based on a master key of the node and the random number; a combination transmission unit for transferring the combination to a key distribution server; a coding result reception unit fore receiving a result of a network coding, corresponding to an ID of the node, from the key distribution server; and a cluster key generation unit for generating a cluster key of the node using the random number of the node and random numbers of nodes adjacent to the node.

The cluster key generation unit may determine whether to apply temporary random number information of the key distribution server based on a total number of nodes forming a cluster in order to generate the cluster key of the node.

The cluster key generation unit may not use the temporary random number information in order to generate the cluster key If the total number of nodes is odd.

The cluster key generation unit uses the temporary random number information in order to generate the cluster key If the total number of nodes is even.

The combination generation unit may generate the combination by performing an XOR operation on the master key of the node and the random number.

The coding result reception unit may receive the result of the network coding, performed on based on the retrieved result of a look-up table, corresponding to the ID of the node, and combinations corresponding to a plurality of nodes, from the key distribution server.

The key distribution server may include a combination reception unit for receiving the combination; a coding unit for searching a look-up table corresponding to the ID of the node, and performing network coding on the result of the search of the look-up table and the combination; a random number generation unit for generating a temporary random number if a total number of nodes forming a cluster is even, and transferring the temporary random number to the coding unit; and a transmission unit for transferring the result of the network coding to the coding result reception unit.

In order to accomplish the above object, the present invention provides a method of a node generating a session key, including generating a random number; generating a combination based on a master key of the node and the random number; transferring the combination to a key distribution server; receiving a network coding result, corresponding to an ID of the node, from the key distribution server; and generating a session key by restoring a random number, corresponding to a counterpart node of the node, using the result of the network coding and the random number.

The generating the combination may include generating the combination by performing an XOR operation on the master key of the node and the random number.

The generating the session key may include transmitting a cryptogram using the generated session key.

The receiving the result of the network coding may include receiving the result of the network coding based on a result of search of a look-up table, corresponding to the ID of the node, obtained by the key distribution server, and combinations corresponding to a plurality of nodes.

The generating the random number may include generating the random number after receiving a start message from the key distribution server.

In order to accomplish the above object, the present invention provides a method of a node generating a cluster key, including generating a random number; generating a combination based on a master key and the random number of the node; transferring the combination to a key distribution server; receiving a result of network coding, corresponding to an ID of the node, from the key distribution server; and generating a cluster key using random numbers, corresponding to nodes adjacent to the node, and the random number of the node.

The generating the cluster key may include determining whether to apply temporary random number information of the key distribution server based on a total number of nodes in order to generate the cluster key.

The determining whether to apply the temporary random number information may include, if the total number of nodes is odd, not using the temporary random number information in order to generate the cluster key.

The determining whether to apply the temporary random number information may include, if the total number of nodes is even, using the temporary random number information in order to generate the cluster key.

The generating the combination may include generating the combination by performing an XOR operation on the master key and the random number of the node.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a muting structure to which a network coding scheme has not been applied;

FIG. 2 is a diagram showing a muting structure to which a network coding scheme has been applied;

FIG. 3 is a diagram showing a conventional method of distributing keys using a network coding scheme;

FIG. 4 shows the construction of an apparatus for generating a session key and a cluster key according to an embodiment of the present invention;

FIG. 5 is a flowchart illustrating a method of generating a session key according to an embodiment of the present invention;

FIG. 6 is a diagram showing the method of generating a session key according to an embodiment of the present invention;

FIG. 7 is a diagram showing a method of generating a session key in large-scale network environment according to an embodiment of the present invention;

FIG. 8 is a diagram showing content transmitted and received in the method of generating a session key in a large-scale network environment according to an embodiment of the present invention;

FIG. 9 is a flowchart illustrating a method of generating a cluster key according to an embodiment of the present invention;

FIG. 10 is a diagram showing a method of generating a cluster key when the total number of nodes forming a cluster is odd according to an embodiment of the present invention;

FIG. 11 is a diagram showing content transmitted and received in the method of generating a cluster key when the total number of nodes forming a cluster is odd according to an embodiment of the present invention;

FIG. 12 is a diagram showing a method of generating a cluster key when the total number of nodes forming a cluster is even according to an embodiment of the present invention; and

FIG. 13 is a diagram showing content transmitted and received in the method of generating a cluster key when the total number of nodes forming a cluster is even according to an embodiment of the present invention.

### DESCRIPTION OF THE PREFERRED EMBODIMENTS

A method and apparatus for generating a session key and a cluster key according to some embodiments of the present invention are described below with reference to the accompanying drawings.

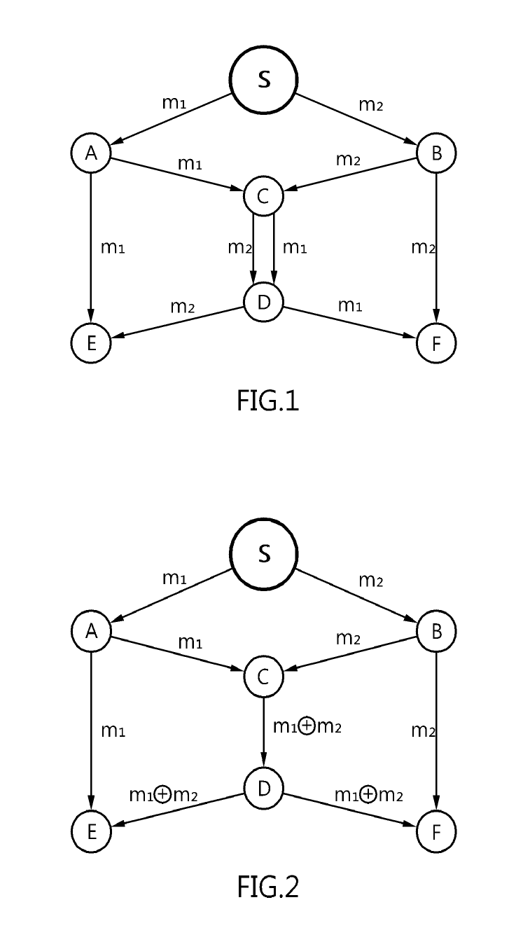

FIGS. 1 and 2 are diagrams respectively showing a routing structure to which a network coding scheme has not been applied and the routing structure to which a network coding scheme has been applied.

First, the network coding scheme corresponds to a scheme in which a node forming a network does not transfer received packets to another node without change, but combines two or more packets and transfers the combined packets.

Referring to FIGS. 1 and 2, the routing structure includes a key distribution server S and a plurality of nodes (e.g., node A, node B, node C, node D, node E, and node F).

In the routing structure (see FIG. 1) to which the network coding scheme has not been applied, the node C receives messages m₁ and m₂ and transfers the received messages m₁ and m₂ to the node D without change. Then the node D transfers the messages m₂ and m₁ to the respective nodes E and F.

In contrast, in the routing structure (see FIG. 2) to which the network coding scheme has been applied, the node C performs an XOR operation on the messages m₂ and m₁ and transfers the XOR operation result m₁⊕m₂ to the node D. Then the node D broadcasts the XOR operation result m₁⊕m₂ to the nodes E and F. That is, there is an advantage in that the node D may transmit the messages m₂ and m₁ at one time.

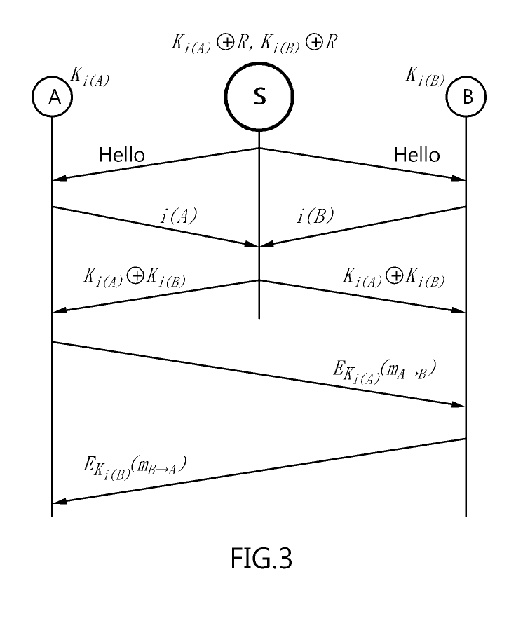

A method of distributing keys using a conventional network coding scheme will now be described in detail below with reference to FIG. 3.

FIG. 3 is a diagram showing a conventional method of distributing keys using a network coding scheme.

Referring to FIG. 3, in the method of distributing keys using a conventional network coding scheme, a key distribution server S corresponds to, for example, a handheld device or a laptop computer, and functions to use the basic operation of the network coding scheme.

Here, a node A and a node B exchange master keys using the key distribution server S.

The master keys are stored in the memory of the key distribution server S in an encrypted form, i.e., in the form of Kᵢ⊕R. Here, R corresponds to a random number. The random number R should not be exposed to other nodes, and is characterized in that it is difficult to predict.

Messages exchanged between the nodes A and B are calculated using XOR network coding between the respective secret keys in the protected form. The messages exchanged between the nodes A and B are represented by the following Equation 1:

K_{i(A)}⊕R⊕K_{i(B)}⊕R=K_{i(A)}⊕K_{i(B)} (1)

After the nodes A and B receive respective messages such as that of Equation 1, the nodes A and B may detect the respective counterpart master keys. The detected master keys are used to directly encrypt the communication messages.

The conventional key distribution method is disadvantageous in that it is vulnerable to a playback attack in which a malicious attacker imitates the key distribution server S. Furthermore, the conventional key distribution method is disadvantageous in that a master key is exposed to a counterpart node and the direct message encryption of a master key increases the possibility that the master key may be exposed to an attacker.

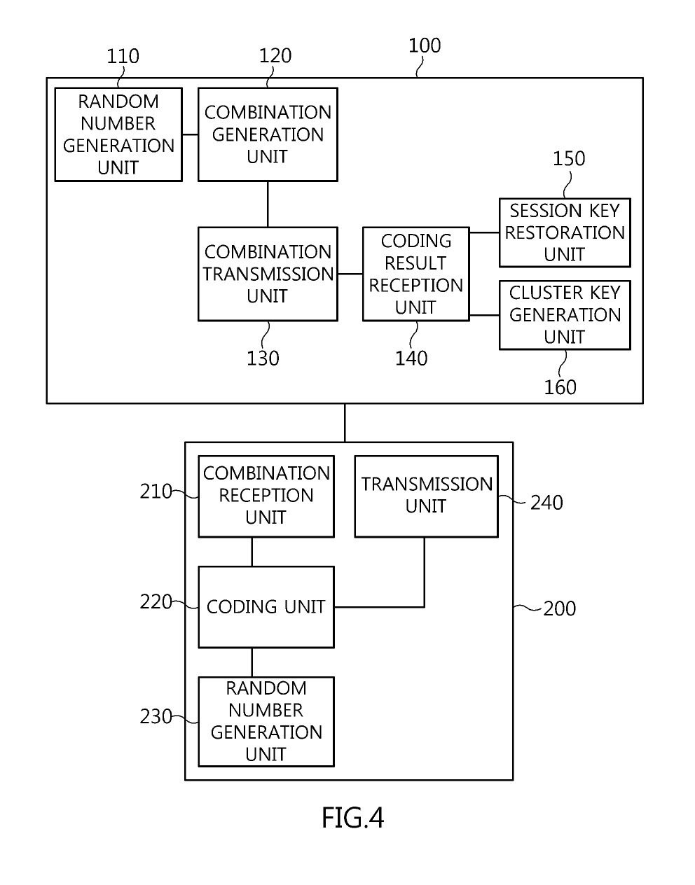

An apparatus 100 for generating a session key and a cluster key using a network coding scheme having improved security will now be described in detail below with reference to FIG. 4.

FIG. 4 shows the construction of the apparatus 100 for generating a session key and a cluster key according to an embodiment of the present invention.

Referring to FIG. 4, the apparatus 100 for generating a session key and a cluster key is placed on the node side, and operates in conjunction with a key distribution server 200.

The apparatus 100 for generating a session key and a cluster key includes a random number generation unit 110, a combination generation unit 120, a combination transmission unit 130, a coding result reception unit 140, a session key restoration unit 150, and a cluster key generation unit 160.

The random number generation unit 110 generates a random number configured to function as a session key, or a random number configured to be used to generate a cluster key.

The combination generation unit 120 generates an XOR combination by performing an XOR operation on the master key and random number of a specific node.

The combination transmission unit 130 transfers the combination, generated by the combination generation unit 120, to the key distribution server 200.

The coding result reception unit 140 receives the result of network coding performed by the key distribution server 200.

The session key restoration unit 150 restores the random number of a counterpart node using its own random number and the result of network coding received from the coding result reception unit 140.

The cluster key generation unit 160 generates a cluster key using its own random number and the result of network coding received from the coding result reception unit 140. When generating the cluster key, the cluster key generation unit 160 determines whether to use temporary random number information R⊕R_{T} of the key distribution server 200 depending on the total number of nodes forming a relevant cluster.

The cluster key generation unit 160, when the total number of nodes is even, may generate a cluster key using a received network coding result, its own random number, and the temporary random number information of the key distribution server 200.

In contrast, the cluster key generation unit 160, when the total number of nodes is odd, may generate a cluster key using only a received network coding result and its own random number.

The key distribution server 200 includes a combination reception unit 210, a coding unit 220, a random number generation unit 230, and a transmission unit 240.

The combination reception unit 210 receives XOR combinations generated by relevant nodes.

The coding unit 220 searches a look-up table corresponding to the ID of each of the specific nodes from which the combination reception unit 210 has received the XOR combination, and performs network coding on the result of the search of the look-up table and the received XOR combination. If the total number of nodes forming a cluster is even, the random number generation unit 230 also generates an XOR combination for a temporary random number R_{T} received from the random number generation unit 230.

If the total number of nodes forming a cluster is even, the random number generation unit 230 generates a temporary random number R_{T}, and transfers the temporary random number R_{T} to the coding unit 220.

Thereafter, the transmission unit 240 transfers the result of network coding, performed by the coding unit 220, to the apparatus 100 for generating a session key and a cluster key on the node side.

In general, a session key is used to protect a payload. For powerful security, the use of a temporary session key is more strongly recommended than the direct use of a master key.

It is assumed that the key distribution server 200 according to an embodiment of the present invention includes master keys in encrypted form, e.g., Kᵢ⊕R. The encryption can protect the master keys of nodes when the key distribution server 200 is captured by a specific attacker.

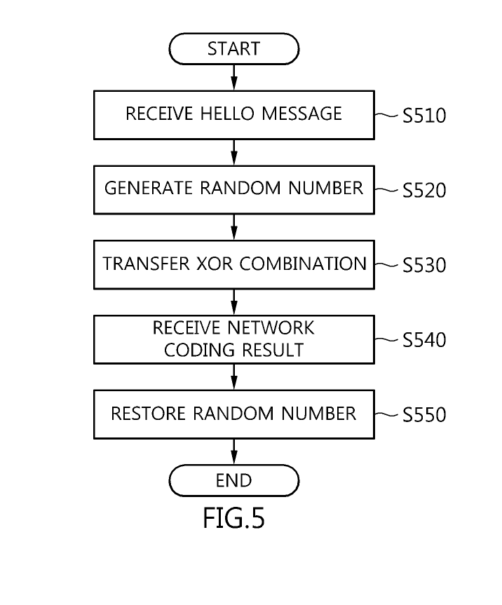

A method of generating a session key will now be described in detail below with reference to FIGS. 5 to 7.

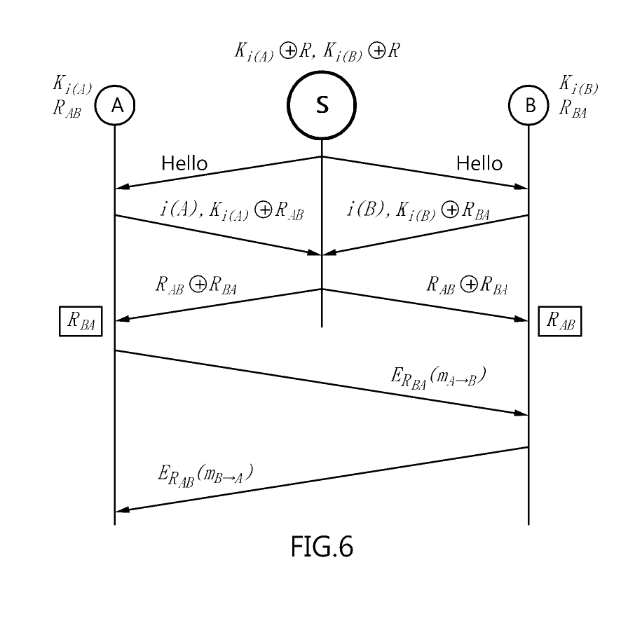

FIG. 5 is a flowchart illustrating the method of generating a session key according to an embodiment of the present invention. Furthermore, FIG. 6 is a diagram showing the method of generating a session key according to an embodiment of the present invention.

First, the apparatus 100 for generating a session key and a cluster key 100 is placed in each node. The apparatus 100 generates the session key of a node and operates in conjunction with the key distribution server 200.

The key distribution server 200 broadcasts a specific message regarding the distribution of keys, e.g., a Hello message informing of the start of a distribution process.

Referring to FIG. 5, nodes receive the Hello message at step S510. Nodes A and B receive the Hello message, as shown in FIG. 6.

Thereafter, each of the nodes A and B generates a random number corresponding to a session key at step S520. For example, the node A may generate a random number RAB, and the node B may generate a random number RBA.

Each of the nodes A and B generates an XOR combination by performing an XOR operation on a master key and the random number and transfers the generated XOR combination and its own ID to the key distribution server 200 at step S530. For example, the node A may transfer its own ID i(A) and an XOR combination K_{i(A)}⊕R_{AB} to the key distribution server 200, and the node B may transfer its own ID i(B) and an XOR combination K_{i(B)}⊕R_{BA} to the key distribution server 200.

At this time, the key distribution server 200 searches a look-up table corresponding to the received ID, and performs network coding on the result Kᵢ⊕R of the searching of the look-up table and the received XOR combination.

Referring to FIG. 6, the key distribution server 200 performs network coding as in the following Equation 2:

K_{i(A)}⊕R⊕K_{i(B)}⊕R⊕K_{i(A)}⊕R_{AB}⊕K_{i(B)}⊕R_{BA}=R_{AB}⊕R_{BA} (2)

Each of the nodes A and: B receives a network coding result, i.e. R_{AB}⊕R_{BA}, at step S510.

Each of the nodes A and B restores the random number of a counterpart node from the network coding result using its own random number at step S550.

Referring to FIG. 6, the node A restores the random number R_{BA} of the node B, corresponding to a counterpart node, from the network coding result R_{AB}⊕R_{BA} using its own random number R_{AB}. Furthermore, the node B restores the random number R_{AB} of the node A, corresponding to a counterpart node, from the network coding result R_{AB}⊕R_{BA} using its own random number R_{AB}.

After the nodes A and B exchange the session keys, each of the nodes A and B may transmit a cryptogram using the exchanged session key, i.e., a newly generated session key.

For example, the node A may generate a cryptogram E_{R}_{_{BA}}(m_{A→B})E_{R}_{_{BA}}(m_{A→B}) using the restored random number R_{BA}. The cryptogram E_{R}_{_{BA}}(m_{A→B})E_{R}_{_{BA}}(m_{A→B}) corresponds to a cryptogram transmitted from the node A to the node B. The node B may decrypt the received cryptogram using its own session key R_{BA} and restore an original message.

Furthermore, the node B may generate a cryptogram E_{R}_{_{AB}}(m_{B→A})E_{R}_{_{AB}}(m_{B→A}) using the restored random number R. The cryptogram) corresponds to a cryptogram transmitted from the node B to the node A. The node A may decrypt the received cryptogram using its own session key R_{AB} and restore an original message.

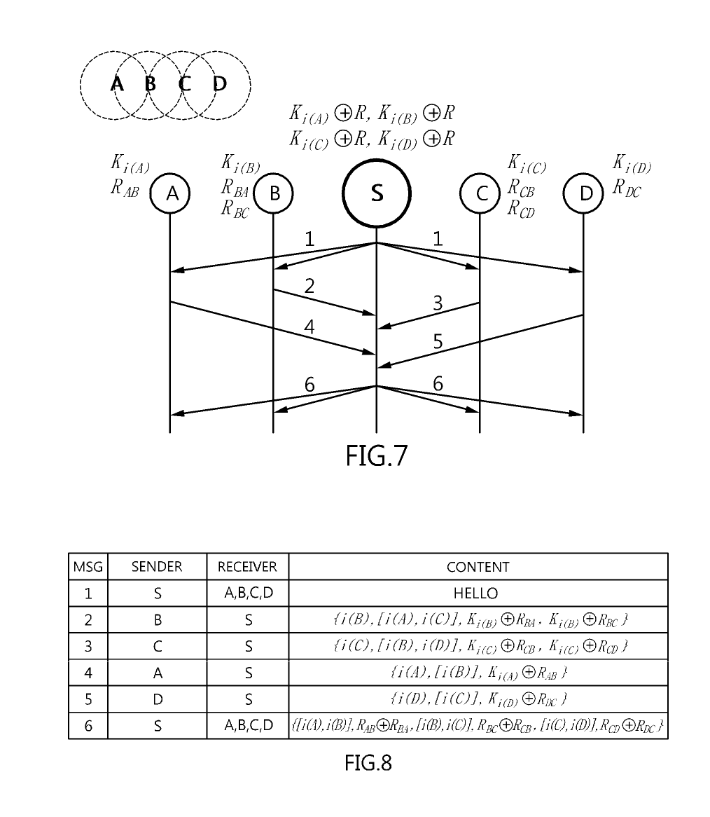

FIG. 7 is a diagram showing a method of generating a session key in a large-scale network environment according to an embodiment of the present invention. FIG. 8 is a diagram showing content transmitted and received in the method of generating a session key in a large-scale network environment according to an embodiment of the present invention.

Referring to FIGS. 7 and 8, a network environment to which the method of generating a session key in a large-scale network environment according to the embodiment of the present invention has been applied includes the key distribution server 200 and a plurality of nodes (e.g., node A, node B, node C, and node D. Here, it is considered that each of the nodes generates a session key because the apparatus 100 for generating a session key and a cluster key is placed in each of the nodes.

The node A should generate a session key while operating in conjunction with node B, and node B should generate session keys while operating in conjunction with not only node A but also node C. Furthermore, each of the nodes C and D should generate session keys while operating in conjunction with nodes within its communication range.

The method of generating a session key in this large-scale network environment will now be described below.

The key distribution server 200 broadcasts a Hello message (\textcircled{1}).

Each of the nodes generates a number of random numbers, functioning as session keys, equal to the number of nodes (hereinafter referred to as “counterpart nodes”) placed within its communication range. Thereafter, each of the nodes generates at least one XOR combination by performing an XOR operation on a master key and at least one random number, and transfers the at least one XOR combination, its own ID and the ID of a counterpart node to the key distribution server 200.

For example, the node B may transfer its own ID i(B), the IDs i(A) and i(C) of the counterpart nodes, and generated XOR combinations, i.e., K_{i(B)}⊕R_{BA} and K_{i(B)}⊕R_{BC}, to the key distribution server 200 (\textcircled{2}).

The node C may transfer its own ID i(C), the IDs i(B) and i(D) of the counterpart nodes, and generated XOR combinations, i.e., K_{i(C)}⊕R_{CB} and K_{i(C)}⊕R_{CD}, to the key distribution server 200 (\textcircled{3}).

The node A may transfer its own ID i(D), the ID i(C) of the counterpart node, and the generated XOR combination, i.e., K_{i(A)}⊕R_{AB}, to the key distribution server 200 (\textcircled{4}).

The node D may transfer its own ID i(D) the ID i(C) of the counterpart node, and the generated XOR combination, i.e., K_{i(D)}⊕R_{DC}, to the key distribution server 200 (\textcircled{5}).

The key distribution server 200 searches a look-up table corresponding to a received ID, and performs network coding on the result of the search of the look-up table and the XOR combination.

For example, the key distribution server 200 may search a look-up table corresponding to each of the IDs received from the node A and the node B and perform network coding on the result of the search of the look-up table and a received XOR combination. Here, the network coding result is R_{AB}⊕R_{BA}(=K_{i(A)}⊕R⊕K_{i(B)}⊕R⊕K_{i(A)}⊕R_{AB}⊕K_{i(B)}⊕R_{BA}).

The key distribution server 200 broadcasts the network coding result (R_{AB}⊕R_{BA}) corresponding to the node A and the node B, a network coding result (R_{BC}⊕R_{CB}) corresponding to node B and node C, and a network coding result (R_{CD}⊕R_{D}) corresponding to node C and node D (\textcircled{6}). Here, the key distribution server 200 broadcasts the network coding result including the ID of a relevant node in order to indicate a node to which each XOR combination corresponds.

After the session keys have been distributed over the large-scale network environment, as shown in FIG. 7, each of the nodes transmits a cryptogram using the newly generated session key.

In general, in order to perform safe broadcasting in the same cluster, a specific key is necessary. Here, the specific key corresponds to a cluster key.

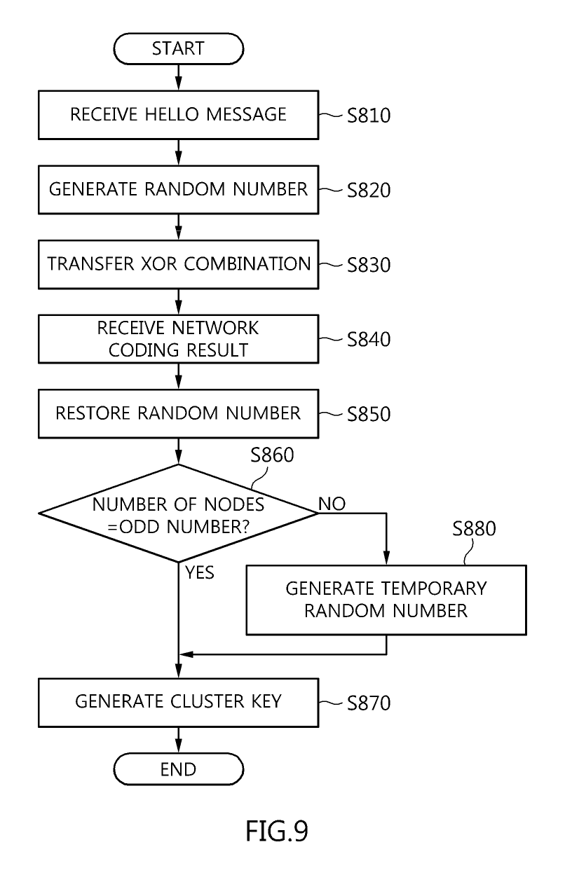

A method of generating a cluster key will no be described in detail with reference to FIGS. 9 to 13.

FIG. 9 is a flowchart illustrating the method of generating a cluster key according to an embodiment of the present invention.

First, the apparatus 100 for generating a session key and a cluster key is placed in each node. The method of generating a cluster key may be applied to each node in the case where nodes placed in the same cluster try to generate one cluster key along with adjacent nodes, but is not limited thereto.

The key distribution server 200 broadcasts a specific message regarding key distribution, e.g., a Hello message informing of the start of a distribution process.

Referring to FIG. 9, the nodes receive the Hello message at step S810.

Each of the nodes generates a random number used to generate a cluster key at step S820.

Each of the nodes generates an XOR combination by performing an XOR operation on a mister key and the generated random number and transfers the generated XOR combination and its own ID to the key distribution server 200 at step S830. Thereafter, the key distribution server 200 searches a look-up table corresponding to a received ID, and performs network coding on the result of the search of the look-up table and the received XOR combination.

Each of the nodes receives the network coding result at step S840.

Thereafter each of the nodes restores the random number of a counterpart node using its own random number and the received network coding result at step S850.

Thereafter, each of the nodes determines whether the number of nodes placed in the same cluster is odd at step S860.

If, as a result of the determination, it is determined that the number of nodes placed in the same cluster is odd, each of the nodes generates a cluster key K_{CLUSTER} by performing an XOR operation on its own node and the random numbers of adjacent nodes at step S870.

In contrast, if, as a result of the determination, it is determined that the number of nodes placed in the same cluster is not odd (i.e., even), each of the nodes restores the temporary random number information R⊕R_{T} of the key distribution server 200 at step S880. Thereafter, each of the nodes generates a cluster key by performing an XOR operation on its own node, the random numbers of adjacent nodes, and the restored temporary random number information R⊕R_{T} at step S870.

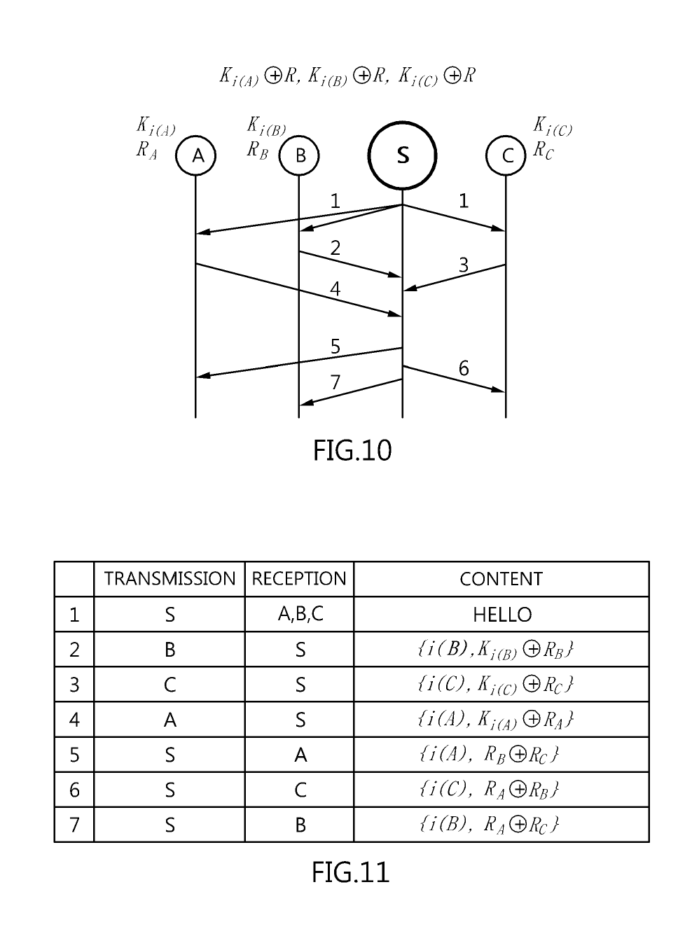

FIG. 10 is a diagram showing a method of generating a cluster key when the total number of nodes forming a cluster is odd according to an embodiment of the present invention. Furthermore, FIG. 11 is a diagram showing content transmitted and received in the method of generating a cluster key when the total number of nodes forming a cluster is odd according to an embodiment of the present invention.

First, it is assumed that nodes A, B and C, i.e., an odd number of nodes, are interconnected and that the nodes A, B, and C want to generate a cluster key using the key distribution server 200.

Referring to FIGS. 10 and 11, the key distribution server 200 broadcasts a Hello message (\textcircled{1}).

The nodes A, B and C generate respective random numbers R_{A}, R_{B} and R_{C}. Thereafter, the nodes A, B, and C generate respective XOR combinations by performing XOR operations on respective master keys and the respective random numbers R_{A}, R_{B} and R_{C}, and transfer their own IDs and K_{i(A)}⊕R_{A}, K_{i(B)}⊕R_{B}, and K_{i(C)}⊕R_{C}, corresponding to the respective generated XOR combinations, to the key distribution server 200 (\textcircled{2}, \textcircled{3}, and \textcircled{4}).

The key distribution server 200 transfers respective network coding results, corresponding to the received IDs, to the respective nodes A, B, and C (\textcircled{5}, \textcircled{6}, and \textcircled{7}). For example, the key distribution server 200 may transfer a network coding result R_{B}⊕R_{C} to the node A.

The nodes A, B and C receive the respective network coding results, and generate a cluster key using their own random numbers and the respective received results. For example, the nodes A, B and C may generate one cluster key (=R_{A}⊕R_{B}⊕R_{C}) using their own nodes and random numbers corresponding to respective counterpart nodes.

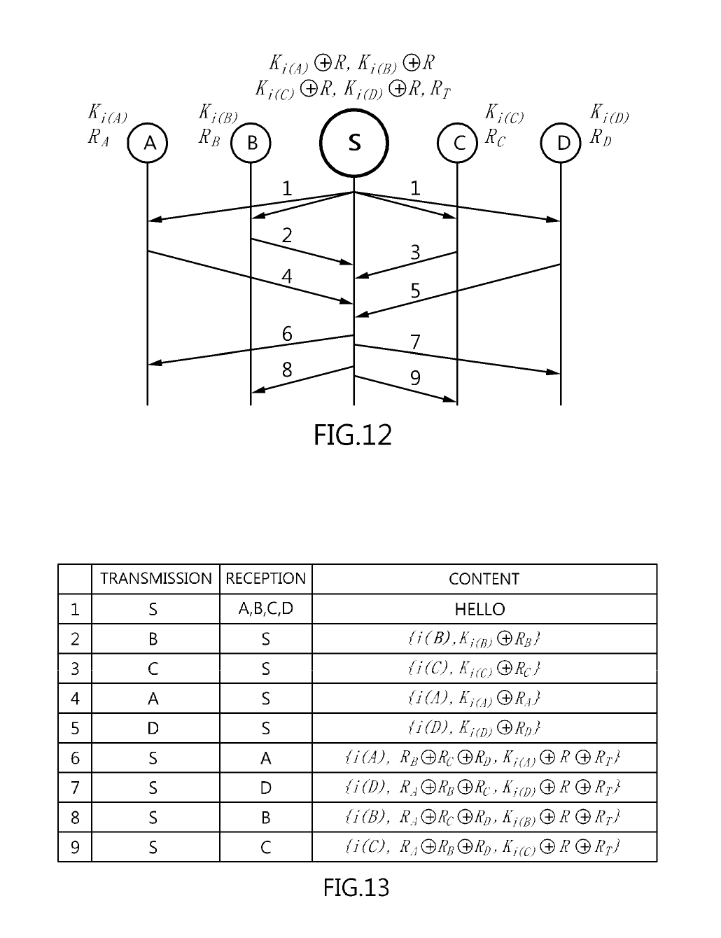

FIG. 12 is a diagram showing a method of generating a cluster key when the total number of nodes forming a cluster is even according to an embodiment of the present invention. Furthermore, FIG. 13 is a diagram showing content transmitted and received in the method of generating a cluster key when the total number of nodes forming a cluster is even according to an embodiment of the present invention.

First, it is assumed that a node A, a node B, a node C, and a node D (i.e., even-numbered nodes) are interconnected and that the nodes A, B, C, and D want to generate a cluster key using the key distribution server 200.

Referring to FIGS. 12 and 13, the key distribution server 200 distributes a Hello message (\textcircled{1}).

The nodes A, B, C and D generate their own random numbers R_{A}, R_{B}, R_{C} and R_{D}. Thereafter, the nodes A, B, C and D generate respective XOR combinations by performing XOR operations on respective master keys and the respective random numbers, and transfers the generated XOR combinations and their own IDs to the key distribution server 200 (\textcircled{2}, \textcircled{3}, \textcircled{4} and (\textcircled{5}).

The key distribution server 200 generates a temporary random number R_{T} which is used to generate a cluster key. Thereafter, the key distribution server 200 searches look-up tables corresponding to the respective IDs received from the nodes A, B, C and D, and performs network coding on retrieved results of the look-up tables and the received XOR combinations. Here, the network coding results are R_{A}⊕R_{B}⊕R_{C}, R_{A}⊕R_{B}⊕R_{D}, R_{A}⊕R_{C}⊕R_{D} and R_{B}⊕R_{C}⊕R_{D}. Thereafter, the key distribution server 200 transfers the network coding results and an XOR combination, corresponding to the temporary random number. R_{T}, to the nodes A, B, C and D (\textcircled{6}\textcircled{7}, \textcircled{8} and \textcircled{9}).

As described above, if the total number of nodes is even, this case includes one more XOR combination corresponding to a response from the key distribution server 200 than the case where the total number of nodes is odd. That is, the key distribution server 200 transfer K_{i(A)}⊕R⊕R_{T}; K_{i(B)}⊕R⊕R_{T}, K_{i(C)}⊕R⊕R_{T} and K_{i(D)}⊕R⊕R_{T} to the respective nodes A, B, C and D.

Thereafter, the nodes A, B, C and D generate a cluster key K_{CLUSTER} by performing an XOR operation on the XOR combinations of the random numbers of their own nodes and adjacent nodes and the temporary random number information R⊕R_{T} received from the key distribution server 200. That is, the nodes A, B, C and D generate a cluster key, i.e., R_{A}⊕R_{B}⊕R_{C}⊕R_{D}⊕R⊕R_{T}; by using K_{i(A)}⊕R⊕R_{T}, K_{i(B)}⊕R⊕R_{T}, K_{i(C)}⊕R⊕R_{T}, and K_{i(D)}⊕R⊕R_{T} received from the key distribution server 200.

For example, if {R_{B}⊕R_{C}⊕R_{D}, K_{i(A)}⊕R⊕R_{T}} are received from the key distribution server 200, the node A may detect R⊕R_{T} using its own master key K_{i(A)}. Accordingly, the node A may generate the cluster key K_{CLUSTER} based on the R⊕R_{T}.

As described above, according to an embodiment of the present invention, the method of generating a session key may preclude the problem of exposing a master key to a counterpart node because temporary random numbers instead of master keys unique to nodes are exchanged as short-term session keys. Furthermore, the method of generating a session key may reduce the possibility of exposing a key that may occur when a unique master key continues to be used because a temporary session key is generated.

According to another embodiment of the present invention, when the method of generating the cluster key of an odd number of nodes is used, a cluster key cannot be inferred from information transferred over a radio section. Furthermore, when the method of generating the cluster key of an even number of nodes is used, an attacker cannot detect a combination for a cluster key from information transferred over a radio section. In other words, if a temporary random number is used in the key distribution server, problems occurring in an even number of nodes can be solved. Accordingly, the method of generating a cluster key according to the embodiment of the present invention has an advantage in that it may defend against a playback attack irrespective of whether the number of nodes forming a cluster is even or odd.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for generating a session key, comprising:
a random number generation unit for generating a random number of a node;
a combination generation unit for generating a combination based on a master key of the node and the random number;
a combination transmission unit for transferring the combination to a key distribution server;
a coding result reception unit for receiving a result of a network coding corresponding to an ID of the node, from the key distribution server; and
a restoration unit for generating a session key by restoring a random number, corresponding to a counterpart node of the node, using the result of the network coding and the random number.

2. The apparatus as set forth in claim 1, wherein the combination generation unit generates the combination by brining an Exclusive OR (XOR) operation on the master key of the node and the random number.

3. The apparatus as set forth in claim 1, wherein the coding result reception unit receives the result of the network coding, performed based on the result of the search of a look-up table corresponding to the ID of the node and combinations corresponding to a plurality of nodes, from the key distribution server.

4. An apparatus for generating a cluster key, comprising:
a random number generation unit for generating a random number of a node;
a combination generation unit for generating a combination based on a master key of the node and the random number;
a combination transmission unit for transferring the combination to a key distribution server;
a coding result reception unit for receiving a result of a network coding, corresponding to an ID of the node, from the key distribution server; and
a cluster key generation unit for generating a cluster key of the node using the random number of the node and random numbers of nodes adjacent to the node.

5. The apparatus as set forth in claim 4, wherein the cluster key generation unit determines whether to apply temporary random number information of the key distribution server based on a total number of nodes forming a cluster in order to generate the cluster key of the node.

6. The apparatus as set forth in claim 5, wherein the cluster key generation unit, if the total number of nodes is odd, does not use the temporary random number information in order to generate the cluster key.

7. The apparatus as set forth in claim 5, wherein the cluster key generation unit, if the total number of nodes is even, uses the temporary random number information in order to generate the cluster key.

8. The apparatus as set forth in claim 4, wherein the combination generation unit generates the combination by performing an XOR operation on the master key of the node and the random number.

9. The apparatus as set forth in claim 4, wherein the coding result reception unit receives the result of the network coding, performed on based on the retrieved result of a look-up table, corresponding to the ID of the node, and combinations corresponding to a plurality of nodes, from the key distribution server.

10. The apparatus as set forth in claim 4, wherein the key distribution server comprises:
a combination reception unit for receiving the combination;
a coding unit for searching a look-up table corresponding to the ID of the node, and performing network coding on the result of the search of the look-up table and the combination;
a random number generation unit for generating a temporary random number if a total number of nodes forming a cluster is even, and transferring the temporary random number to the coding unit; and
a transmission unit for transferring the result of the network coding to the coding result reception unit.

11. A method of a node generating a session key, comprising:
generating a random number;
generating a combination based on a master key of the node and the random number;
transferring the combination to a key distribution server;
receiving a network coding result, corresponding to an ID of the node, from the key distribution server; and
generating a session key by restoring a random number, corresponding to a counterpart node of the node, using the result of the network coding and the random number.

12. The method as set forth in claim 11, wherein the generating the combination comprises generating the combination by performing an XOR operation on the master key of the node and the random number.

13. The method as set forth in claim 11, wherein the generating the session key comprises transmitting a cryptogram using the generated session key.

14. The method as set forth in claim 11, wherein the receiving the result of the network coding comprises receiving the result of the network coding based on a result of search of a look, up table, corresponding to the ID of the node, obtained by the key distribution server, and combinations corresponding to a plurality of nodes.

15. The method as set forth in claim 11, wherein the generating the random number comprises generating the random number after receiving a start message from the key distribution server.

16. A method of a node generating a cluster key, comprising:
generating a random number;
generating a combination based on a master key and the random number of the node;
transferring the combination to a key distribution server;
receiving a result of network coding, corresponding to an ID of the node, from the key distribution server; and
generating a cluster key using random number, corresponding to nodes adjacent to the node, and the random number of the node.

17. The method as set forth in claim 16, wherein the generating the cluster key comprises determining whether to apply temporary random number information of the key distribution server based on a total number of nodes in order to generate the cluster key.

18. The method as set forth in claim 17, wherein the determining whether to apply the temporary random number information comprises, if the total number of nodes is odd, not using the temporary random number information in order to generate the cluster key.

19. The method as set forth in claim 17, wherein the determining whether to apply the temporary random number information comprises, if the total number of nodes is even, using the temporary random number information in order to generate the cluster key.

20. The method as set forth in claim 16, wherein the generating the combination comprises generating the combination by performing an XOR operation on the master key and the random number of the node.
